(19) United States
(12) Patent Application Publication
(10) Pub. No.: US 2004/0106699 A1
(43) Pub. Date: Jun. 3, 2004

(54) Ink capable of printing fine pattern and printed matter

(75) Inventors: Seiji Ishikawa, Chiba-shi (JP); Yuji Matsui, Ube-Shi (JP); Yoshiki Tanaka, Ube-shi (JP); Masahiro Naiki, Ube-shi (JP)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Ube Industries, Ltd., Ube-shi (JP)

(21) Appl. No.: 10/681,693

(22) Filed: Oct. 7, 2003

(30) Foreign Application Priority Data
Oct. 9, 2002 (JP) 2002-295891

(51) Int. Cl. C03C 17/00; C09D 5/00

(52) U.S. Cl. 523/160; 523/161

(57) ABSTRACT

An object of the present invention is to provide an ink which can dispense with complicated and highly expensive steps, as required in the case of using a photosensitive resin composition, such as coating step, exposure step, development step, washing step and drying or heat-treatment step, and can produce printed matter comprising a cured coating film having a fine pattern on a substrate by a simple method of printing the ink by screen printing and then heat-treating it, without generating a large amount of waste solutions, including an alkali solution, accompanying the development or washing.

An ink comprising a resin component and a fine filler is disclosed, wherein the edge of a cured coating film obtained through printing by screen printing and then heat treatment has a tilt angle of 15° or more with respect to the printing surface.

### BACKGROUND OF THE INVENTION

1. Field of the Invention

The present invention relates to an ink capable of giving a cured coating film, through printing by screen printing and then heat treatment, whose edge has a tilt angle of 15° or more with respect to the printed surface. More specifically, the present invention relates to an ink capable of economically forming a cured coating film having a fine pattern through simple steps more favorable to the environment, a method for producing a printed matter comprising a cured coating film obtained by printing the ink by screen printing and then heat-treating it, and a printed matter comprising a cured coating film obtained by printing the ink by screen printing and then heat-treating it.

2. Description of Related Art

As the method for forming a coating film having a fine pattern, such as a thin insulating layer, on the surface of a substrate, conventionally known is a method of using an ink comprising a photosensitive resin.

For example, when an ink comprising a photocurable resin is used, after the coating of the ink, a pattern portion is irradiated with light such as ultraviolet ray to cure the resin of the irradiated portion and the unnecessary portion is removed through a step such as development or washing with an organic solvent. According to this method, a predetermined pattern is formed by the irradiation of light, so that the edge of the cured coating film can be kept almost vertical to the coated surface and a cured coating film having a fine and high resolution pattern can be easily obtained. Therefore, this method is often used in the field where refined formation and high resolution are required and, for example, in the process of producing a semiconductor device, or for forming an insulating layer of an IC packaged component, or a black matrix layer of a color filter for display devices such as liquid crystal display.

However, this method requires complicated and highly expensive steps such as a coating step, an exposure step, a development step, a washing step and a drying or a heat-treatment step. Furthermore, this method has a problem that a large amount of waste solutions, including an alkali solution, are produced by the development or the washing steps.

A coating film such as insulting layer can also be formed on a substrate surface by using an ink comprising a thermosetting resin. However, the normal thermosetting resin composition cannot be easily printed to form a fine pattern by screen printing. Even if printed, the coating film is fluidized by the subsequent heat treatment and the edge of the cured coating film after the heat treatment forms a gently inclined face having a very small tilt angle of less than 10° with respect to the printing surface. Therefore, for example, in forming a cured coating film having a thickness of approximately from a few μm to tens of μm, it is difficult to obtain a printed matter comprising a cured coating film having a fine pattern, for example, a line-like cured coating film with a width of about 30 μm or less, preferably on the order of 5 to 20 μm, a circular cured coating film with a diameter of about 30 μm or less, preferably on the order of 5 to 20 μm, a cured coating film having a line-like space with a width of about 30 μm or less, preferably on the order of 5 to 20 μm, or a cured coating film having a circular space with a diameter of about 30 μm or less, preferably on the order of 5 to 20 μm.

Some studies have already been made to form a cured coating film, suitable as an insulating layer of electrical and electric components on a substrate surface, by using an ink comprising a thermosetting resin. As for the ink capable of forming a cured coating film suitable as the insulting layer, various compositions comprising a resin component and a fine filler are known. These compositions can be printed by screen printing (see, for example, U.S. Pat. No. 5,643,986 based on Japanese Unexamined Patent Publication (Kokai) No. 9-118807). However, there is no known technique specifically providing an ink capable of giving a cured coating film through printing by screen printing and then heat treatment, where the edge has a tilt angle of 15° or more with respect to the printing surface, and capable of producing a printed matter comprising the cured coating film having a fine pattern.

An object of the present invention is to provide an ink which can dispense with complicated and highly expensive steps, such as those required in the case of using an ink comprising a photosensitive resin, and can easily produce a printed matter comprising a cured coating film having a fine pattern, through printing by screen printing and heat treatment, without generating a large amount of waste solution. Another object of the present invention is to provide a method for producing a printed matter comprising a cured coating film having a fine pattern by printing the above-described ink by screen printing and then heat-treating it, and a printed matter comprising a cured coating film obtained by printing the above-described ink on a substrate surface by screen printing and then heat-treating it.

### SUMMARY OF THE INVENTION

To attain the above object, the present invention provides the following:

[1] An ink comprising a resin component and a filler, wherein a cured coating film obtained through printing of said ink by screen printing and then heat treatment thereof has an edge with a tilt angle of 15° or more with respect to the printed surface.

[2] The ink as set forth in [1], wherein at the temperature of printing, the complex viscosity (η*) of the ink is from 10,000 to 300,000 poise at the frequency of 1 rad/sec, and at the same time, the complex viscosity (η*) of the ink is from 1,000 to 30,000 poise at the frequency of 10 rad/sec.

[3] The ink as set forth in [1] or [2], wherein at the temperature of printing, the complex viscosity (η*) of the ink at the frequency of 1 rad/sec is from 4 to 16 times the complex viscosity (η*) of the ink at the frequency of 10 rad/sec.

[4] The ink as set forth in [1] to [3], wherein said resin component exhibits a heat curing reaction in a temperature range from 100 to 210° C.

[5] The ink as set forth in [1] to [4], wherein said resin component exhibits heat curing by a reaction of an aromatic dicarboxylic acid anhydride group or an aromatic dicarboxylic acid mono ester group with an epoxy group or a blocked isocyanate group, a reaction of a blocked isocyanate group with a hydroxyl group or a carboxyl group, a reaction of an epoxy group with a hydroxyl group, a carboxyl group or an amide group, or a combination of said reactions.

[6] The ink as set forth in [1] to [5], which comprises from 30 to 300 parts by weight of the filler, having an average particle size of less than 1.0 μm, per 100 parts by weight of the resin component.

[7] The ink as set forth in [1] to [6], wherein the resin component comprises (a) a polyimidosiloxane comprising a tetracarboxylic acid component and a diamine component containing a diaminopolysiloxane represented by formula (1), and (b) an epoxy compound and/or a blocked

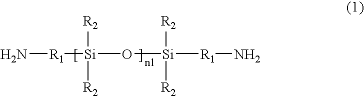

wherein R₁ represents a divalent hydrocarbon group or aromatic group, each R₂ independently represents a monovalent hydrocarbon group or aromatic group, and n1 represents an integer of 3 to 30.

[8] The ink as set forth in [7], wherein the diamine component of the polyimidosiloxane is an aromatic diamine having a hydroxyl group and/or a carboxyl group on a side chain thereof.

[9] A method for producing a printed matter comprising a cured coating film, said method comprising printing the ink set forth in [1] to [8] by screen printing and then heat-treating it at a temperature of 60 to 210° C.

[10] The method set forth in [9], to produce printed matter having patterns defined by a line-and-space of 80 μm or less.

[11] The method set forth in [9], to produce printed matter having patterns defined by a line-and-space of 50 μm or less.

[12] The method set forth in [9], to produce printed matter having patterns defined by a line-and-space of 30 μm or less.

[13] A printed matter comprising a cured coating film obtained by printing the ink set forth in [1] to [8] by screen printing and then heat-treating it.

[14] The printed matter set forth in [13], which has patterns defined by a line-and-space of 80 μm or less.

[15] The printed matter set forth in [13], which has patterns defined by a line-and-space of 50 μm or less.

[16] The printed matter set forth in [13], which has patterns defined by a line-and-space of 30 μm or less.

### BRIEF DESCRIPTION OF THE DRAWINGS

FIG. 1 is a schematic view for describing the method of measuring the tilt angle of an edge of a cured coating film formed according to the present invention with respect to a printing surface.

FIG. 2 is a scanning electron microphotograph of the cross section of a cured coating film, for measuring a tilt angle of the edge of the cured coating film with respect to the printing surface (substrate surface) in Example 3 of the present invention.

FIG. 3 is a scanning electron microphotograph of the cross section of the cured coating film formed in Example 5 of the present invention.

### DETAILED DESCRIPTION OF THE INVENTION

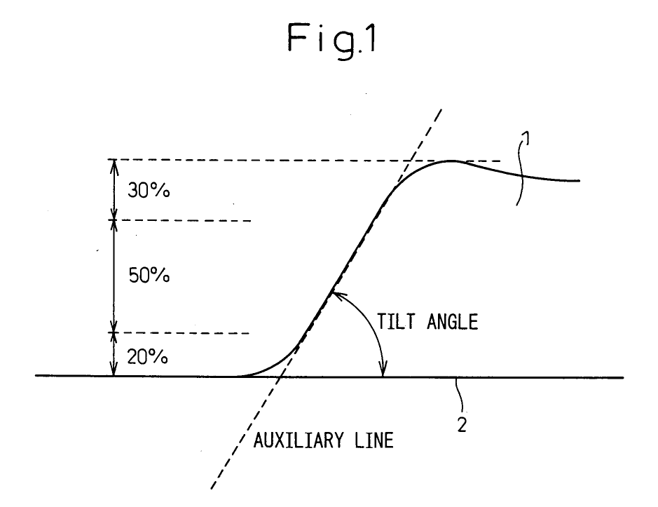

The present invention is an ink comprising a resin component and a fine filler, wherein the edge of a cured coating film obtained through printing by screen printing and then heat treatment has a tilt angle of 15° or more, preferably 20° or more, more preferably 30° or more, with respect to the printed surface. In the present invention, as shown in the schematic cross-sectional view of FIG. 1, the tilt angle of the edge of the cured coating film is an angle made by the printing surface (substrate surface) and the inclined face of the cured coating film when the cured coating film has a thickness of approximately from 5 to 10 μm and this is defined as an average angle in the center 50% portion of the thickness excluding the upper 30% portion and the lower 20% portion. In the present invention, the cross section of the edge of the cured coating film obtained through printing on a glass plate by screen printing and then heat treatment is observed by a scanning electron microscope and thereby the title angle is measured. The tilt angle of the edge of the cured coating film is basically determined by the construction material of the coating film and does not depend on the construction material of the substrate.

The conventional ink comprising a thermosetting resin can be printed to form a fine pattern by screen printing or the like but when a heat treatment is applied for performing drying or a curing reaction, the coating film is fluidized and cannot keep the shape formed at the printing and the edge of the cured coating film forms a gently inclined face having a very small tilt angle with respect to the printing surface. In other words, the coating film formed at the printing expands to fill the space and therefore, a printed matter comprising a cured coating film having a fine pattern or a highly precision pattern cannot be obtained.

The cured coating film obtained by printing the ink of the present invention by screen printing and then heat-treating it can easily keep the shape formed at the printing even when subjected to a heat treatment, and the edge can keep a tilt angle of 15° or more, preferably 20° or more, more preferably 30° or more, with respect to the printing surface, so that a fine pattern can be formed with high precision. Therefore, in the case of forming a cured coating film having a thickness of approximately from a few μm to tens of μm, a printed matter comprising a cured coating film having a fine pattern can be obtained, such as a line-like cured coating film with a width of about 30 μm or less, preferably on the order of 5 to 20 μm, a circular cured coating film with a diameter of about 30 μm or less, preferably on the order of 5 to 20 μm, a cured coating film having a line-like space with a width of about 30 μm or less, preferably on the order of 5 to 20 μm, or a cured coating film having a circular space with a diameter of about 30 μm or less, preferably on the order of 5 to 20 μm.

The ink of the present invention is preferably characterized in that at the temperature on printing, the complex viscosity (η*) of the ink is from 10,000 to 300,000 poise, more preferably from 20,000 to 200,000 poise, when the frequency is 1 rad/sec, and at the same time, the complex viscosity (η*) of the ink is from 1,000 to 30,000 poise, more preferably from 2,000 to 20,000 poise, when the frequency is 10 rad/sec.

When the complex viscosity (η*) at the temperature on printing is 30,000 poise or less at a frequency of 10 rad/sec, the ink can be printed to form a fine pattern at ordinary temperature by screen printing, however, if the complex viscosity (η*) exceeds 30,000 poise, problems arise, for example, the plate releasing is worsened, ink it is difficult to uniformly spread the ink over the printing surface by a squeegee or the cured coating film obtained has a severely uneven surface and, therefore, the ink cannot be printed by screen printing. On the other hand, if the complex viscosity (η*) is less than 1,000 poise, the coating film is readily fluidized in the heat-treatment step after printing, due to its excessively low viscosity, and a cured coating film having a fine pattern can hardly be obtained.

When the complex viscosity (η*) at the temperature of printing is 10,000 poise or more at a frequency of 1 rad/sec, the coating film can be prevented from fluidizing in the heat-treatment step after printing and therefore, the edge of the cured coating film can easily make a tilt angle of 15° or more, preferably 20° or more, more preferably 30° or more, with respect to the printing surface. If the complex viscosity (η*) is less than 10,000 poise, the coating film cannot be prevented from fluidizing in the heat-treatment step after printing and, as a result, the edge of the cured coating film has a very small tilt angle with respect to the printing surface and printed matter comprising a cured coating film having a fine pattern can hardly be obtained. On the other hand, if the complex viscosity (η*) exceeds 300,000 poise, there arise problems in the production and, for example, the filler or other additives cannot be uniformly mixed, and this is not preferred.

In the present invention, the temperature at printing means a temperature when the ink of the present invention is printed by screen printing. This temperature is usually in the range from 0 to 60° C., preferably from 10 to 40° C., more preferably from 20 to 30° C., and typically room temperature or 25° C.

Furthermore, the ink of the present invention is preferably characterized in that the complex viscosity (η*) of the ink at the frequency of 1 rad/sec is approximately from 4 to 16 times, more preferably 4.5 to 14, further preferably on the order of 5 to 11 times, the complex viscosity (η*) of the ink at the frequency of 10 rad/sec. If the above ratio of the complex viscosity (η*) is less than 4 times, printed matter comprising a cured coating film having a fine pattern can hardly be obtained by screen printing. On the other hand, an ink where the ratio exceeds 16 times is difficult to obtain. In other words, the ink of the present invention preferably exhibits a relatively low viscosity when a shear stress is applied at printing, and exhibits a relatively high viscosity, as large as several times or more the relatively low viscosity when almost no shear stress is applied, when standing.

The resin component constituting the ink of the present invention preferably comprises a resin having a thermosetting reactivity. In particular, the resin component is preferably constituted such that the resin having a thermosetting reactivity substantially undertakes a thermosetting reaction in the temperature range from 100 to 210° C., preferably from 100 to 180° C., more preferably from 110 to 180° C.

If the substantial curing reaction takes place at less than 100° C., the ink is readily gelled or increases in viscosity during storage for a long time and, also, the ink is gelled or increases in viscosity at the printing step and cannot be stably printed by screen printing. On the other hand, if the substantial curing reaction takes place at a temperature exceeding 210° C., a heating device for heating the ink to a temperature exceeding 210° C. is necessary and this is not preferred in view of equipment and working. Furthermore, problems due to heat may be disadvantageously caused to the materials or parts other than the coating film, which are heat-treated at the same time.

To speak specifically about the thermosetting resin suitable as the resin component constituting the ink of the present invention, the ink is preferably constituted of a resin component which substantially undertakes a thermosetting reaction by a reaction of an aromatic dicarboxylic acid anhydride group or an aromatic dicarboxylic acid more ester group with an epoxy group or a blocked isocyanate group, a reaction of a blocked isocyanate group with a hydroxyl group or a carboxyl group, a reaction of an epoxy group with a hydroxyl group, a carboxyl group or an amido group, or a combination of any two or more of these reactions.

In any combination of these reactions, a substantial thermosetting reaction does not take place at a temperature of less than 100° C. but a thermosetting reaction readily occurs at a temperature of 100 to 210° C., preferably 110° C. to 180° C.

The ink of the present invention comprises a resin component and a fine filler and the resin component is suitably a thermosetting resin composition comprising a polyimidosiloxane, a polyamidoimide, a polyol, a polyester or the like having a reactive functional group, an epoxy compound and/or a blocked polyvalent isocyanate, and the like, capable of being readily cured at a temperature of 100 to 210° C., preferably 110 to 180° C. More specifically, for example, a resin composition comprising (a) a polyimidosiloxane consisting of a tetracarboxylic acid component and a diamine component containing a diaminopolysiloxane represented by formula (1), (b) an epoxy compound and/or a blocked polyvalent isocyanate and, if desired, (c) an organic solvent can be suitably used. The component (b) is preferably contained in an amount of 0.5 to 50 parts by weight, more preferably 2 to 40 parts by weight, particularly 2 to 30 parts by weight based on 100 parts by weight of the component (a).

The ink comprising this resin component can be suitably used particularly in the process of producing a semiconductor device or for forming an insulating layer of an IC packaged component or a black matrix layer of a color filter for display devices such as liquid crystal device, because the cured coating film obtained is excellent in the electrical characteristics such as electrical insulating property and also in characteristics such as adhesion to other materials, heat resistance, soldering resistance, bending resistance and humidity resistance.

The present invention is described below based on the ink comprising this resin component, but the present invention is not limited thereto.

The polyimidosiloxane can be obtained by using a tetracarboxylic acid component and a diamine component almost in equimolar amounts, preferably in a molar ratio such that the tetracarboxylic acid component is approximately from 1.0 to 1.2 mol per mol of the diamine component, and reacting these components in an organic solvent. If the molar ratio of the tetracarboxylic acid component exceeds this range, the viscosity of polyimidosiloxane becomes excessively low and the obtained ink comprising the polyimidosiloxane disadvantageously loses its printing properties.

The polyimidosiloxane preferably has a logarithmic viscosity (0.5 g/100 ml) of 0.05 to 3, more preferably from 0.1 to 1.

The polyimidosiloxane can be obtained by reacting a tetracarboxylic acid component and a diamine component containing a diaminopolysiloxane represented by formula (1) at a relatively low temperature, for example, approximately from 10 to 80° C., to form a polyamic acid and then thermally or chemically imidating the polyamic acid, or through a one-stage reaction of polymerizing and imidating those components at a relatively high temperature, for example, approximately from 130 to 250° C., in an organic solvent by omitting the step of forming a polyamic acid.

The reaction of a tetracarboxylic acid component and a diamine component may be either a random reaction or a block reaction. For example, homopolymerization products resulting from individual reactions performed every each diamine species (depending on the case, followed by a recombination reaction) may be mixed. Also, an acid-terminal oligomer previously prepared by using excess tetracarboxylic acid and an amine-terminal oligomer previously prepared by using excess diamine may be mixed to give an almost equimolar ratio between the acid component and the diamine component, and may be further reacted.

The produced polyimidosiloxane can be used as it is without isolating it from the solution.

Preferred examples of the tetracarboxylic acid component of the polyimidosiloxane include aromatic tetracarboxylic acids such as 3,3′,4,4′-biphenyltetracarboxylic acid, 2,2′,3,3′-biphenyltetracarboxylic acid, 2,3,3′,4′-biphenyltetracarboxylic acid, 3,3′,4,4′-benzophenonetetracarboxylic acid, bis(3,4-dicarboxyphenyl)ether, pyromellitic acid, 2,3,6,7-naphthalenetetracarboxylic acid, 1,2,5,6-naphthalenetetracarboxylic acid, 1,2,4,5-naphthalenetetracarboxylic acid, 1,4,5,8-naphthalenetetracarboxylic acid, 2,2-bis(2,5-dicarboxyphenyl)propane, 1,1-bis(2,3-dicarboxyphenyl)ethane and bis(3,4-dicarboxyphenyl)sulfone, acid dianhydrides or ester derivatives thereof, alicyclic tetracarboxylic acids such as cyclopentanetetracarboxylic acid, cyclohexanetetracarboxylic acid and methylcyclohexenetetracarboxylic acid, and acid dianhydrides or ester derivatives thereof.

These tetracarboxylic acid components may be used individually or in combination of two or more thereof.

Among these, 2,3,3′,4′-biphenyltetracarboxylic acid, 3,3,4,4-benzophenonetetracarboxylic acid, bis(3,4-dicarboxyphenyl)ether, and acid dianhydrides or ester derivatives thereof are preferred, because a high-concentration polyimidosiloxane solution can be obtained by virtue of their high solubility in a solvent and an insulating film having high heat resistance can be obtained.

The tetracarboxylic acid component is preferably a tetracarboxylic acid dianhydride facilitated in the reaction with diamine.

In the case where the tetracarboxylic acid dianhydride is used in an amount of 1.05 molar times the diamine and an unreacted anhydrous ring remains, the reaction solution may be used as it is but it may be subjected to ring-opening half esterification using an esterifying agent. The amount of alcohol used as the esterifying agent is preferably from 1.1 to 20 times equivalent, more preferably from 1.5 to 5 times equivalent, to the excess tetracarboxylic acid dianhydride. If the ratio of alcohols is small, a large amount of an unreacted anhydrous ring remains to give an ink poor in storage stability and excess alcohol works as a poor solvent to decrease the solid content concentration and, as a result, a coating film is disadvantageously difficult to form by screen printing.

When an esterifying agent is used, the reaction solution may be used as it is but may also be used after removing excess alcohols by heating or by distillation under reduced pressure.

The diamine component of the polyimidosiloxane preferably comprises from 45 to 95 mol %, more preferably from 55 to 95 mol % of the above-described diaminopolysiloxane, from 0.5 to 40 mol % of an aromatic diamine having a polar group and from 0 to 50 mol % of a diamine having a plurality of benzene rings. If any one component content is excessively large or small and deviates from this range, for example, the obtained polyimidosiloxane decreases in solubility in an organic solvent or suffers from low compatibility with other organic components and, when an ink using the polyimidosiloxane is printed and then heat-treated, the resulting cured coating film has a small radius of curvature to readily cause curling or is decreased in the bending resistance, adhesive property, heat resistance or humidity resistance.

The diaminopolysiloxane constituting the diamine component of the polyimidosiloxane is a compound represented by formula (1). In the formula, R₁ is preferably a divalent hydrocarbon group having from 1 to 5 carbon atoms or a phenyl group, more preferably a propylene group, R₂ is preferably an alkyl group having from 1 to 5 carbon atoms or a phenyl group, and n1 is preferably an integer of 4 to 30, more preferably from 4 to 20. Here, when the diaminopolysiloxane comprises a mixture of two or more compounds, n1 is calculated from the amino equivalent.

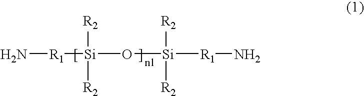

wherein R₁ represents a divalent hydrocarbon group or aromatic group, each R₂ independently represents a monovalent hydrocarbon group or aromatic group, and n1 represents an integer of 3 to 30.

Specific compound examples of the diaminopolysiloxane include α,ω-bis(2-aminoethyl)polydimethylsiloxane, α,ω-bis(3-aminopropyl)polydimethylsiloxane, α,ω-bis(4-aminophenyl)polydimethylsiloxane, α,ω-bis(4-amino-3-methylphenyl)polydimethylsiloxane, α,ω-bis(3-aminopropyl)polydiphenylsiloxane and α,ω-bis(4-aminobutyl)polydimethylsiloxane.

The aromatic diamine having a polar group, constituting the diamine component of the polyimidosiloxane, is preferably a compound represented by formula (2):

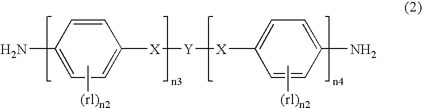

wherein X and Y each independently represents a direct bond, CH₂, C(CH₃)₂, C(CF₃)₂, 0, a benzene ring or SO₂, r1 represents COOH or OH, n2 represents 1 or 2, n3 and n4 each independently represents 0, 1 or 2, preferably 0 or 1, and at least one of n3 and n4 is 1 or 2.

Examples of the aromatic diamine compound having a polar group include diamine compounds having an OH group, such as diaminophenol compounds, e.g., 2,4-diaminophenol; hydroxybiphenyl compounds, e.g., 3,3′-diamino-4,4′-dihydroxybiphenyl, 4,4′-diamino-3,3′-dihydroxybiphenyl, 4,4′-diamino-2,2′-dihydroxybiphenyl, 4,4′-diamino-2,2′,5,5′-tetrahydroxybiphenyl; hydroxydiphenylalkane compounds, e.g., 3,3′-diamino-4,4′-dihydroxydiphenylmethane, 4,4′-diamino-3,3′-dihyddroxydiphenylmethane, 4,4′-diamino-2,2′-dihydroxydiphenylmethane, 2,2-bis[3-amino-4-hydroxyphenyl]propane, 2,2-bis[4-amino-3-hydroxyphenyl]propane, 2,2-bis[3-amino-4-hydroxyphenyl]hexafluoropropane, 4,4-diamino-2,2′,5,5′-tetrahydroxydiphenylmethane; hydroxydiphenylether compounds, e.g., 3,3′-diamino-4,4′-dihydroxydiphenylether, 4,4′-diamino-3,3′-dihydroxydiphenylether, 4,4′-diamino-2,2′-dihydroxydiphenylether, 4,4′-diamino-2,2′,5,5′-tetrahydroxydiphenylether; hydroxydiphenylsulfone compounds, e.g., 3,3′-diamino-4,4′-dihydroxydiphenylsulfone, 4,4′-diamino-3,3′-dihydroxydiphenylsulfone, 4,4′-diamino-2,2′-dihydroxydiphenylsulfone, 4,4′-diamino-2,2′,5,5′-tetrahydroxydiphenylsulfone; bis(hydroxyphenoxyphenyl)alkane compounds, e.g., 2,2-bis[4-(4-amino-3-hydroxyphenoxy)phenyl]propane; bis(hydroxyphenoxy)biphenyl compounds, e.g., 4,4′-bis(4-amino-3-hydroxyphenoxy)biphenyl; and bis(hydroxyphenoxyphenyl)sulfone compounds, e.g., bis[4-(4-amino-3-hydroxyphenoxy)phenyl]sulfone.

Other examples of the aromatic diamine compound having a polar group include diamine compounds having a COOH group, such as benzenecarboxylic acids, e.g., 3,5-diaminobenzoic acid; carboxybiphenyl compounds, e.g., 3,3′-diamino-4,4′-dicarboxybiphenyl, 4,4′-diamino-3,3′-dicarboxybiphenyl, 4,4′-diamino-2,2′-dicarboxybiphenyl, 4,4′-diamino-2,2′,5,5′-tetracarboxybiphenyl; carboxydiphenylalkane compounds, e.g., 3,3′-diamino-4,4′-dicarboxydiphenylmethane, 4,4′-diamino-3,3′-dicarboxydiphenylmethane, 4,4′-diamino-2,21-dicarboxydiphenylmethane, 2,2-bis[3-amino-4,-carboxyphenyl]propane, 2,2-bis[4-amino-3-carboxyphenyl]propane, 2,2-bis[3-amino-4-carboxyphenyl]hexafluoropropane, 4,4′-diamino-2,2′,5,5′-tetracarboxybiphenyl; carboxydiphenylether compounds, e.g., 3,3′-diamino-4,4′-dicarboxydiphenylether, 4,4′-diamino-3,3′-dicarboxydiphenylether, 4,4′-diamino-2,2′-dicarboxydiphenylether, 4,4′-diamino-2,2′,5,5′-tetracarboxydiphenylether; carboxydiphenylsulfone compounds, e.g., 3,3′-diamino-4,4′-dicarboxydiphenylsulfone, 4,4′-diamino-3,3′-dicarboxydiphenylsulfone, 4,4′-diamino-2,2′,5,5′-tetracarboxydiphenylsulfone; bis(carboxyphenoxyphenyl)alkane compounds, e.g., 2,2-bis[4-(4-amino-3-carboxyphenoxy)phenyl]propane; bis(carboxyphenoxy)biphenyl compounds, e.g., 4,4′-bis(4-amino-3-carboxyphenoxy)biphenyl; and bis(carboxyphenoxyphenyl)sulfone compounds, e.g., bis[4-(4-amino-3-carboxyphenoxy)phenyl]sulfone. The aromatic diamine having a plurality of benzene rings, constituting the diamine component of the polyimidosiloxane, is preferably a compound represented by formula (3):

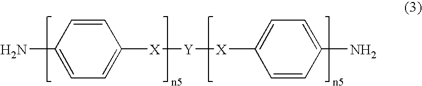

wherein X and Y each independently represents a direct bond, CH₂, C(CH₃)₂, C(CF₃)₂₁ 0, a benzene ring or SO₂, and n5 represents 1 or 2.

Examples of the aromatic diamine compound having a plurality of benzene rings include aromatic diamines having two benzene rings, such as 4,4′-diaminodiphenylether, 4,4′-diaminodiphenylmethane, 4,4′-diaminodiphenylsulfone and o-tolidine; aromatic diamines having three benzene rings, such as 1,4-bis(4-aminophenoxy)benzene, 1,3-bis(4-aminophenoxy)benzene, 1,3-bis(3-aminophenoxy)benzene and 1,4-bis(4-aminophenyl)benzene; and aromatic diamines having four benzene rings, such as bis[4-(4-aminophenoxy)phenyl]sulfone, 2,2-bis[4-(4-aminophenoxy)phenyl]propane and 1,4-bis(4-aminophenyl)biphenyl.

Examples of the organic solvent used in the reaction for preparing the polyimidosiloxane include nitrogen-containing solvents such as N,N-dimethylacetamide, N,N-diethylacetamide, N,N-dimethylformamide, N,N-diethylformamide, N-methyl-2-pyrrolidone, 1,3-dimethyl-2-imidazolidinone and N-methylcaprolactam; sulfur atom-containing solvents such as dimethylsulfoxide, diethylsulfoxide, dimethylsulfone, diethylsulfone and hexamethylsulfonamide; oxygen-containing solvents such as phenol-base solvents (e.g., cresol, phenol, xylenol), diglyme-base solvents (e.g., diethylene glycol dimethyl ether (diglyme), triethylene glycol dimethyl ether (triglyme), tetraglyme), acetone, ethylene glycol, dioxane and tetrahydrofuran. In particular, N-methyl-2-pyrrolidone, N,N-dimethylsulfoxide, N,Ndimethylformamide, N,N-diethylformamide, N,N-dimethylacetamide, N,N-diethylacetamide, y-butyrolactone, triethylene glycol dimethyl ether, diethylene glycol dimethyl ether, and the like, can be preferably used. If desired, an aromatic hydrocarbon-base solvent such as benzene, toluene and xylene, or another organic solvent such as solvent naphtha and benzonitrile may be used in combination.

The polyvalent isocyanate compound used as the resin component is a compound having two or more isocyanate groups within one molecule, and a blocked polyvalent isocyanate compound where isocyanate groups are blocked by a blocking agent is suitably used.

Examples of the polyvalent isocyanate compound includes aliphatic, alicyclic and aromatic diisocyanates. Specific examples thereof include 1,4-tetramethylene diisocyanate, 1,5-pentamethylene diisocyanate, 1,6-hexamethylene diisocyanate, 2,2,4-trimethyl-1,6-hexamethylene diisocyanate, lysine diisocyanate, 3-isocyanatomethyl-3,5,5-trimethylcyclohexyl isocyanate (isophorone diisocyanate), 1,3-bis(isocyanatomethyl)-cyclohexane, 4,4′-dicyclohexylmethane diisocyanate, tolylene diisocyanate, 4,4′-diphenylmethane diisocyanate, 1,5-naphthalene diisocyanate, tolidine diisocyanate and xylylene diisocyanate.

The polyvalent isocyanate compound may also be a compound derived from an aliphatic, alicyclic or aromatic polyvalent isocyanate compound. More specifically, the polyvalent isocyanate compound may be, for example, an isocyanurate-modified polyvalent isocyanate, a biuret-modified polyvalent isocyanate or a urethane-modified polyvalent isocyanate.

Examples of the blocking agent include alcohol-base, phenol-base, activated methylene-base, mercaptan-base, acid amide-base, acid imide-base, imidazole-base, urea-base, oxime-base, amine-base, imide-base and pyridine-base compounds. These may be used individually or in a mixture.

Specific examples of the blocking agent include alcohol-base compounds such as methanol, ethanol, propanol, butanol, 2-ethylhexanol, methylcellosolve, butylcellosolve, methylcarbitol, benzylalcohol and cyclohexanol; phenol-base compounds such as phenol, cresol, ethylphenol, butylphenol, nonylphenol, dinonylphenol, styrenated phenol and hydroxybenzoic acid ester; activated methylene-base compounds such as dimethyl malonate, diethyl malonate, methyl acetoacetate, ethyl acetoacetate and acetylacetone; mercaptan-base compounds such as butylmercaptan and dodecylmercaptan; acid amide-base compounds such as acetoanilide, acetic acid amide, ε-caprolactam, δ-valerolactam and γ-butyrolactam; acid imide-base compounds such as succinic acid imide and maleic acid imide; imidazole-base compounds such as imidazole and 2-methylimidazole; urea-base compounds such as urea, thiourea and ethylene urea; oxime-base compounds such as formaldoxime, acetoaldoxime, acetoxime, methyl ethyl ketoxime and cyclohexanonoxime; amine-base compounds such as diphenylamine, aniline and carbazole; imine-base compounds such as ethyleneimine and polyethyleneimine; bisulfites such as sodium bisulfite; and pyridine-base compounds such as 2-hydroxypyridine and 2-hydroxyquinoline.

Particularly preferred polyvalent isocyanate compounds used as the resin component are BURNOCK D-550 (produced by Dai-Nippon Ink & Chemicals, Inc.), Elastron BN-P17 (blocked 4,4′-diphenylmethanediisocyanate, produced by Dai-ichi Kogyo Seiyaku Co., Ltd., blocking agent: oxime-base compound] and Elastron BN-04, BN-08, BN-44 and BN-45 (having 3 to 5 functional groups per molecule of blocked urethane-modified polyvalent isocyanate, all produced by Daiichi Kogyo Seiyaku Co., Ltd., each an aqueous emulsion which can be used after drying and isolation).

In the case where the resin component comprises a blocked isocyanate, for example, dibutyltin dilaurate is preferably added as a dissociating catalyst for dissociating and removing the blocking agent in the blocked polyvalent isocyanate compound. The amount of the dissociating catalyst is preferably on the order of 0 to 25 parts by weight per 100 parts by weight of the blocked polyvalent isocyanate.

The epoxy compound used as the resin component is preferably a liquid or solid epoxy resin having an epoxy equivalent of approximately from 100 to 1,000 and a molecular weight of approximately from 300 to 5,000. Preferred examples thereof include bisphenol A-type or bisphenol F-type epoxy resin, specifically, Epicote 806 and Epicote 825 produced by Japan Epoxy Resins Co., Ltd.; and trifunctional or greater functional epoxy resin, specifically, Epicote 152, Epicote 154, Epicote 180 Series, Epicote 157 Series and Epicote 1032 Series produced by Japan Epoxy Resins Co., Ltd., and MTO 163 produced by Ciba Geigy.

In the present invention, a catalyst component for accelerating the curing of epoxy resin, such as hydrazides and imidazoles, may be used together with the epoxy resin to give a catalyst amount of, for example, on the order of 0.01 parts by weight, preferably 0.01 part by weight or more and at the same time, 10 parts by weight or less, preferably 5 parts by weight or less, per 100 parts by weight of the epoxy resin.

The ink of the present invention comprises a fine filler. The ink suitably contains a filler having an average particle size (median diameter) of 1.0 μm or less, more preferably from 0.0001 to 0.4 μm, in an amount of 20 parts by mass or more, preferably 30 parts by weight or more, more preferably 40 parts by weight or more and at the same time, 300 parts by weight or less, preferably 200 parts by weight or less, per 100 parts by weight of the resin composition.

In order to obtain an ink having a complex viscosity (η*) specified in the present invention, it is very effective that the ink of the present invention contains a filler having an average particle size of less than 0.3 μm, preferably 0.1 μm or less, more preferably 50 nm or less, in an amount of at least 20 parts by weight or more, preferably 30 parts by weight or more as an essential component of the filler.

The filler may be an organic filler or an inorganic filler and preferred examples thereof include inorganic fillers such as Aerosil, barium sulfate and spherical silica, and organized clay minerals. The shape of the filler is not particularly limited and the filler may have any shape such as spherical, plate-like or layered form.

Specific examples of the inorganic filler which is suitably used include Aerosil 130 (fine powder silica, average particle size: 16 nm) and Aerosil 50 (fine powder silica, average particle size: 30 nm) produced by Nippon Aerosil Co., Ltd.; Barium Sulfate B-30 (barium sulfate, average particle size: 0.3 μm) produced by Sakai Chemical Industry Co., Ltd.; and Admafine S0-C2 (spherical silica, average particle size: 0.5 μm) produced by Shin-Etsu Quartz Products Co., Ltd.).

The organized clay mineral is a clay-organic composite where an organic compound and/or an organic ion is taken in between layers of a layered clay mineral, and this is produced, for example, by replacing the exchangeable inorganic ion between layers of a layered clay mineral with an organic ion. In this organized clay mineral, the interlayer distance of crystal is expanded and disaggregation readily takes place in the crystal unit of one layer or several layers. Accordingly, this clay mineral disperses as a fine filler having an average particle size of 0.1 μm or less in the resin composition.

Specific examples of suitable organized clay minerals include montmorillonite treated with an aminododecanoic acid, such as NANOMER I.24T produced by Nanocor, and SOMASIF ME-100 produced by CO-OP Chemical.

The ink of the present invention may contain an organic solvent, if desired. As the organic solvent, the organic solvent used in the preparation of the polyimidosiloxane may be used and suitable examples thereof include nitrogen-containing solvents such as N,N-dimethylacetamide, N,N-diethylacetamide, N,N-dimethylformamide, N,N-diethylformamide, N-methyl-2-pyrrolidone, 1,3-dimethyl-2-imidazolidinone and N-methylcaprolactam; sulfur atom-containing solvents such as dimethylsulfoxide, diethylsulfoxide, dimethylsulfone, diethylsulfone and hexamethylsulfonamide; oxygen-containing solvents such as phenol-base solvents (e.g., cresol, phenol, xylenol), diglyme-base solvents (e.g., diethylene glycol dimethyl ether (diglyme), triethylene glycol dimethyl ether (triglyme), tetraglyme), acetone, ethylene glycol, dioxane and tetrahydrofuran. In particular, N-methyl-2-pyrrolidone, N,N-dimethylsulfoxide, N,N-dimethylformamide, N,N-diethylformamide, N,N-dimethylacetamide, N,N-diethylacetamide, y-butyrolactone, triethylene glycol dimethyl ether, diethylene glycol dimethyl ether and the like can be preferably used.

The ink of the present invention may preferably comprise (b) from 2 to 40 parts by weight of a polyvalent isocyanate compound and/or an epoxy compound and (c) from 30 to 300 parts by weight of a fine filler, per (a) 100 parts by weight of a polyimidosiloxane, and if desired, preferably comprises (d) an organic solvent.

If the amount of the polyvalent isocyanate compound and/or epoxy compound used is larger or smaller than the above-described range, curing insufficiently proceeds, the resin composition is readily gelled to raise a problem in the storage stability, or the coating film after heat-treatment decreases in heat resistance or adhesion to other members. Accordingly, the polyvalent isocyanate compound and/or epoxy compound is preferably used in the above-described range.

The polyvalent isocyanate compound and the epoxy compound may be used individually or in combination. When these are used in combination, the total of the amounts of both compounds used preferably falls in the above-described range.

If the amount of the fine filler used is less than the above-described range, the obtained resin composition is difficult to adjust to have a predetermined viscosity, whereas if it exceeds this range, a homogeneous dispersion is difficult to prepare and the obtained resin composition has an excessively high viscosity, giving rise to poor printability.

The organic solvent is suitably used in an amount of 50 to 200 parts by weight per 100 parts by weight of the polyimidosiloxane in view of workability as an ink, properties of the solution, and control of the coating film shape in printing and heat-treatment steps.

In the ink of the present invention, a filler other than the above-described fine filler, a pigment, a dye, a defoaming agent and the like may be added, if desired. The filler other than the fine filler is not particularly limited in the kind and shape, however, a filler having a particle size small enough to enable printing by screen printing is preferred.

The ink of the present invention can be obtained by thoroughly mixing and thereby homogeneously dispersing a polyimidosiloxane, a polyvalent isocyanate compound and/or an epoxy compound, a fine filler and, if desired, an organic solvent each in a predetermined amount.

The mixing method is not particularly limited as long as an ink where respective components are thoroughly homogeneously dispersed and mixed can be obtained. For example, the mixing can be suitably performed by a method of preparing a crude mixture using an ordinary method, thoroughly kneading the mixture at room temperature in a three-roll mill or the like, and thoroughly removing air bubbles mixed in at the kneading.

In the case of using a solution composition of polyimidosiloxane, the reaction solution at the preparation of polyimidosiloxane may be used as it is or may be used after diluting the reaction solution with an appropriate organic solvent. The organic solvent is preferably an organic solvent having a boiling point of 140 to 210° C., more preferably 180° C. or more, because the dissipation of the organic solvent due to evaporation is remarkably reduced. Furthermore, such an organic solvent is optimal for performing the printing by screen printing without any trouble.

The ink of the present invention is printed by screen printing and then heat-treated and thereby a cured coating film can be obtained. As for the heat treatment method, the ink is screen-printed on a substrate surface to form a predetermined pattern and then preferably heat-treated through two stages, that is, at 60 to 120° C., preferably on the order of 70 to 120° C., for approximately from 5 to 60 minutes, and then at 120 to 210° C., preferably on the order of 120 to 190° C., for 5 to 120 minutes. By performing such a heat treatment, a cured coating film having a fine pattern can be obtained.

The ink of the present invention can provide a cured coating film through printing by screen printing and then heat treatment, where the tilt angle of the edge is 15° or more, preferably 20° or more, more preferably 30° or more, with respect to the printing surface (substrate surface). Therefore, in the case of forming a cured coating film having a thickness of approximately from a few μm to tens of μm, a printed matter comprising a cured coating film having a fine pattern can be produced, such as a line-like cured coating film with a width of about 30 μm or less, preferably on the order of 5 to 20 μm, a circular cured coating film with a diameter of about 30 μm or less, preferably on the order of 5 to 20 μm, a cured coating film having a line-like space with a width of about 30 μm or less, preferably on the order of 5 to 20 μm, or a cured coating film having a circular space with a diameter of about 30 μm or less, preferably on the order of 5 to 20 μm. By virtue of this capability, the ink of the present invention can be suitably used in the field where a refined and high-precision or high-resolution coating film is required, for example, in the process of producing a semiconductor device or for forming an insulating layer of an IC packaged component or a black matrix layer of a color filter for a display device such as liquid crystal display.

In accordance with the present invention, there is therefore provided a method for producing a printed matter as described above, to obtain a printed matter including a patterns defined a line-and-space of preferably 80 μm or less, more preferably 50 μm or less, particularly 30 μm or less. A printed matter including a pattern defined a line-and-space of, for example, 80 μm or less does not necessarily mean that the pattern is composed only of line and space of 80 μm or less, but does mean that the printed matter includes at least a portion which can be formed only by using a pattern of a line-and-space of 80 μm or less.

As the substrate on which the ink of the present invention is printed, any material may be used according to the objective use. Suitable examples thereof include a transparent substrate such as glass plate, an insulating substrate such as polyimide film or glass epoxy-laminated substrate, and a solid electric element.

### EXAMPLES

The present invention is described in greater detail below by referring to Examples, however, the present invention is not limited to these Examples.

The measurement and evaluation were performed by the following methods.

[Measurement of Complex Viscosity (η*)]

The measurement was performed in a nitrogen gas stream by using a Dynamic Spectrometer RDSII (manufactured by Rheometrics) in a frequency sweep mode, at a temperature of 25° C. and a strain of 10%, with 25 mmφ parallel plates spaced 2 mm apart, and the complex viscosity (η*) was determined when the frequency was 1 rad/sec and 10 rad/sec.

[Measurement of Viscosity of Solution]

The measurement was performed by using E-type viscometer (manufactured by Tokyo Keiki Co., Ltd.), ST Rotor, at a rotation number of 10 rpm and a temperature of 25° C.

[Evaluation of Printing Operability]

A screen printing was performed in a high-precision press (manufactured by Microtek Inc.) using a high-precision screen plate at a squeegee speed of 15 mm/sec. The printing operability was rated ◯ (good) when the ink could be printed by a normal printing operation, and rated x (bad) when the ink could not be uniformly expanded on the screen by the squeegee or the plate releasing was bad (the printing surface of substrate and the screen were stuck and could not be easily separated).

[Evaluation of Printability of Fine Pattern]

The ink was printed on a glass substrate by screen printing in a high-precision press (manufactured by Microtek Inc.) using a high-precision screen plate so that a coating film having a pattern comprising a line with a thickness of approximately from 5 to 10 μm and a width of about 20 μm and a space with a width of about 20 μm could be obtained, and thereafter heat-treated in an oven at 80° C. for 30 minutes and then at 180° C. for 30 minutes. The pattern of the obtained coating film was observed by an optical microscope or a scanning electron microscope and the printability was rated ◯ (good) when an objective pattern was obtained, and rated x (bad) when the space was filled and a clear pattern was not obtained.

[Measurement of Tilt Angle of Coating Film Edge with Respect to Printing Surface]

The ink was printed on a glass substrate by screen printing in a high-precision press (manufactured by Microtek Inc.) using a high-precision screen plate so that a line-like cured coating film with a thickness of approximately from 5 to 10 μm could be obtained, and thereafter heat-treated in an oven at 80° C. for 30 minutes and then at 180° C. for 30 minutes. An epoxy resin was coated on the surface of this sample to entirely cover the cured coating film and then cured. This coating film was cut to obtain a cross section perpendicular to the line direction. The obtained cross section was observed by a scanning electron microscope and the tilt angle made by the substrate surface and the inclined face at the edge of the coating film was measured. The tilt angle was determined as an average angle in the center 50% portion of the thickness at a largest thickness part excluding the upper 30% portion and the lower 20% portion.

[Measurement of Electrical Insulating Property]

Surface resistivity:

Measured according to JIS C-2103.

Volume resistivity:

Measured according to JIS C-2103.

Dielectric breakdown voltage:

Measured according to JIS C-2318.

Abbreviations used in Examples indicate the following compounds.

a-BPDA: 2,3,3′,4′-Biphenyltetracarboxylic acid dianhydride

DAPSi: α,ω-Bis(3-aminopropyl)polydimethylsiloxane (amino equivalent: 460 or 455, n1≈10)

MBAA: Bis(3-carboxy-4-aminophenyl)methane

BAPP: 2,2-Bis[4-(4-aminophenoxy)phenyl]propane

DABA: 3,5-diaminobenzoic acid

TG: Triglyme

Fillers used in Examples are shown below.

Aerosil 130:

Fine powder silica having an average particle size of 16 nm, produced by Nippon Aerosil Co., Ltd.

Aerosil 50:

Fine powder silica having an average particle size of 30 nm, produced by Nippon Aerosil Co., Ltd.

Barium Sulfate B-30:

Average particle size: 0.3 μm, produced by Sakai Chemical Industry Co., Ltd.

Spherical Silica Admafine S0-C2:

Average particle size: 0.5 μm, produced by Shin-Etsu Quartz Products Co., Ltd.

### Reference Example 1

In a 500 ml-volume glass-made flask, 58.84 g (0.2 mol) of a-BPDA and 116 g of TG were weighed and stirred under heating at 185° C. in a nitrogen atmosphere. Thereto, 156.4 g (0.17 mol) of DAPSi (amino equivalent:

460) and 50 g of TG were added and stirred under heating at 185° C. for 2 hours. To the resulting reaction solution, 8.59 g (0.03 mol) of MBAA and 50 g of TG were added and stirred under heating at 185° C. for 5 hours.

The resulting reaction solution was cooled to 25° C. The obtained polyimidosiloxane solution had a solid content (polyimidosiloxane) concentration of 50.3 wt %, a logarithmic viscosity (0.5 g/100 ml) of 0.173 and a solution viscosity of 35 poise.

The solution was added with TG to adjust the polyimidosiloxane concentration to 50 wt %.

Subsequently, in a glass vessel, 2.14 g of epoxy resin Epicote 157S07 (produced by Japan Epoxy Resins Co., Ltd.) and 0.06 g of imidazole-base catalyst CURE-SOL (produced by Shikoku Corp.) were added to 35 g of the polyimidosiloxane solution prepared above, and stirred for 2 hours. The resulting solution had a solution viscosity of 40 poise.

### Reference Example 2

In a 500 ml-volume glass-made flask, 58.84 g (0.2 mol) of a-BPDA and 170 g of TG were weighed and stirred under heating at 180° C. in a nitrogen atmosphere and were cooled to 100° C. Thereto, 127.4 g (0.14 mol) of DAPSi (amino equivalent: 455) and 50 g of TG were added and stirred under heating at 180° C. for 60 minutes.

The resulting reaction solution was cooled to 25° C.

Thereto, 13.52 g (0.03 mol) of BAPP, 4.56 g (0.03 mol) of DABA and 79 g of TG were added and stirred under heating at 180° C. for 5 hours.

The resulting reaction solution was cooled to 25° C. The obtained polyimidosiloxane solution had a solid content (polyimidosiloxane) concentration of 40 wt %, a logarithmic viscosity (0.5 g/100 ml) of 0.200 and a solution viscosity of 28 poise.

Subsequently, in a glass-made vessel, 2.88 g of epoxy resin Epicote 157S07 (produced by Japan Epoxy Resin Co., Ltd.) and 0.03 g of imidazol-base catalyst CURE-SOL (produced by Shikoku Corp.) were added to 40 g of the polyimidosiloxane solution prepared above and stirred for 2 hours. The resulting solution had a solution viscosity of 41 poise.

### Examples 1 to 5

To the solution obtained in Reference Example 1 or 2, a filler was added to have a resin composition shown in Table 1 and mixed. The obtained composition was treated twice in a three-roll mill and further treated in “AWATORI RENTARO” (manufactured by SHINKY) at a revolution of 2,000 rpm and an autorotation of 600 rpm, thereby performing kneading and defoaming, to obtain an ink.

The complex viscosity (η*) of each ink obtained was measured and the results are shown in Table 1.

Subsequently, each ink was printed on a glass substrate surface by screen printing and then heat-treated to obtain a printed matter comprising a cured coating film having a predetermined pattern. The printed matter obtained was evaluated for printing workability, the printability of fine pattern, and the tilt angle of the coating film edge with respect to the printing surface. The results obtained are shown in Table 1.

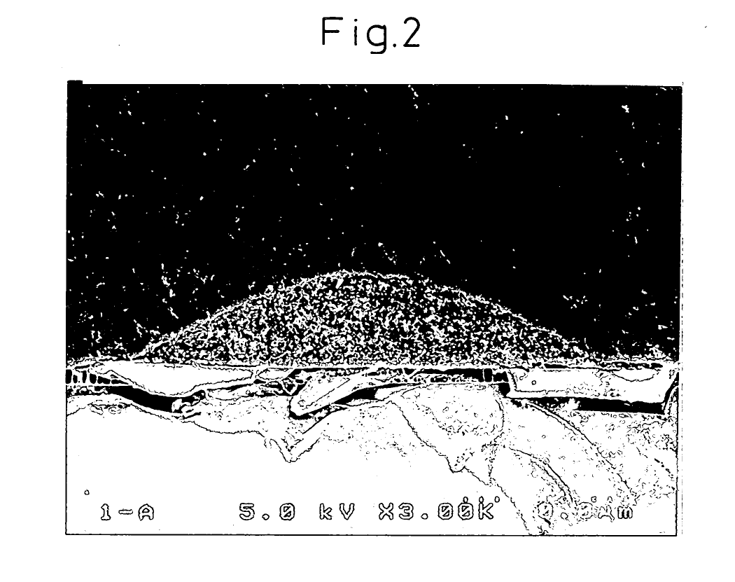

FIG. 2 shows a photograph of a cross section perpendicular to the line direction of the cured coating film of the sample prepared by using the ink of Example 3 for the evaluation on printability of a fine pattern. It is seen that the cured coating film is formed at a width of about 20 μm (in this photograph, the glass substrate is broken due to cutting to obtain the cross section of the sample).

### Comparative Examples 1 and 2

The same operation as in Examples 1 to 4 was performed except for changing the amount of filler added as shown in Table 1. The results obtained are shown in Table 1.

TABLE 1

| | Compositional Ratio of | | | | | Complex Viscosity (25° C.) | | | Printability | | |
|---|---|---|---|---|---|---|---|---|---|---|---|
| | Ink (parts by weight)* | | | | | Frequency: | Frequency: | Viscosity | | Printability | Tilt Angle |
| | Resin | Aerosil | Aerosil | Barium | Spherical | 1 rad/sec | 10 rad/sec | Ratio, | Printing | of Fine | of Coating |
| | Component | 130 | 50 | sulfate | Silica | (a) | (b) | (a)/(b) | Workability | Pattern | Film Edge |
| Example 1 | Reference | 35 | — | 20 | — | 127000 | 18200 | 6.98 | ∘ | ∘ | 38° |
| | Example 1 | | | | | | | | | | |
| | 100 | | | | | | | | | | |
| Example 2 | Reference | — | 80 | 30 | — | 90400 | 14500 | 6.23 | ∘ | ∘ | 28° |
| | Example 1 | | | | | | | | | | |
| | 100 | | | | | | | | | | |
| Example 3 | Reference | — | 45 | 100 | — | 22500 | 4250 | 5.29 | ∘ | ∘ | 30° |
| | Example 1 | | | | | | | | | | |
| | 100 | | | | | | | | | | |
| Example 4 | Reference | — | 45 | — | 250 | 85900 | 12200 | 7.34 | ∘ | ∘ | 35° |
| | Example 1 | | | | | | | | | | |
| | 100 | | | | | | | | | | |
| Example 5 | Reference | — | 80 | 30 | — | 11200 | 2400 | 4.68 | ∘ | ∘ | 25° |
| | Example 2 | | | | | | | | | | |
| | 100 | | | | | | | | | | |
| Comparative | Reference | 4 | 12 | — | — | 250 | 300 | 0.83 | ∘ | x | 9° |
| Example 1 | Example 1 | | | | | | | | | | |
| | 100 | | | | | | | | | | |
| Comparative | Reference | 35 | — | 30 | — | >300000 | 51200 | — | x | x | — |
| Example 2 | Example 1 | | | | | | | | | | |
| | 100 | | | | | | | | | | |

*The compositional ratio of ink is shown by parts by weight of filler assuming that the resin component, excluding solvent, is 100 parts by weight.

The ink of Example 1 was printed on a copper foil by screen printing and heat-treated at 80° C. for 30 minutes and further at 180° C. for 30 minutes to prepare a cured coating film having a thickness of 30 μm. This cured coating film was measured for electrical characteristics and, as a result, the volume resistivity was 0.04×10¹⁶ Ω·cm, the surface resistivity was 18.8×10¹⁶ Ω or more and the dielectric breakdown voltage was 75 kv/mm, revealing excellent insulating properties.

### Example 6

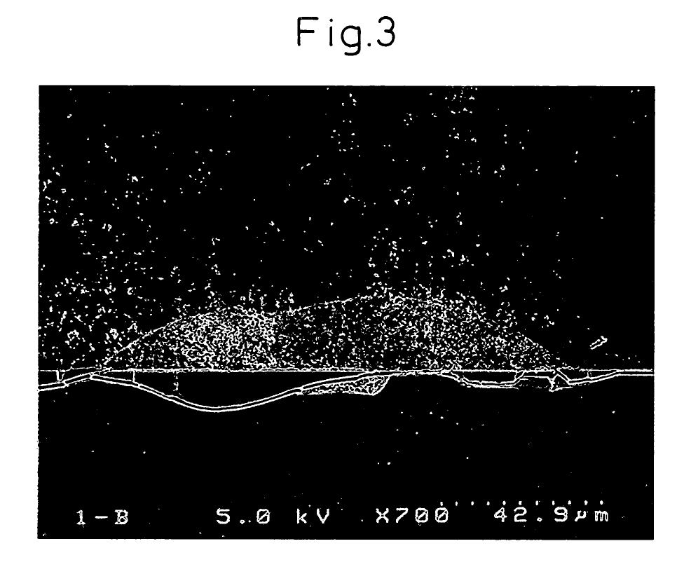

The ink of Example 4 was printed on a glass substrate by screen printing and then heat-treated at 80° C. for 30 minutes and further at 180° C. for 30 minutes to obtain a cured coating film having a thickness of about 20 μm. An epoxy resin was coated on the surface of this sample to entirely cover the cured coating film and then cured. This cured coating film was cut to obtain a cross section right-angled to the line direction and the obtained cross section of the cured coating film was observed by a scanning electron microscope. FIG. 3 shows a scanning electron microphotograph of the cross section (in this photograph, the glass substrate is broken due to cutting to obtain the cross section of the sample). The edge of this cured coating film had a tilt angle of 30° or more with respect to the printing surface (substrate surface). From this result, it is seen that when the ink is printed by screen printing and then subjected to a predetermined heat-treatment, even if the thickness is about 20 μm, a cured coating film having, for example, a line-like or circular space with a width or diameter of about 30 μm or less, preferably on the order of 5 to 20 μm, can be obtained.

As described in the foregoing pages, the present invention provides the following effects. That is, when the ink of the present invention is used, complicated and highly expensive steps, as required in the case of using a photosensitive resin composition, such as coating step, exposure step, development step, washing step and drying or heat-treatment step, are not necessary. Furthermore, printed matter comprising a cured coating film having a fine pattern can be produced on a substrate by a simple method of printing the ink by screen printing and then heat-treating it, without generating a large amount of waste solutions, including alkali solution, accompanying development or washing.

1. An ink comprising a resin component and a filler, wherein a cured coating film obtained through printing of said ink by screen printing and then heat treatment thereof has an edge with a tilt angle of 15° or more with respect to the printed surface.

2. The ink as claimed in claim 1, wherein, at the temperature of printing, the complex viscosity (η*) of the ink is from 10,000 to 300,000 poise at the frequency of 1 rad/sec, and at the same time, the complex viscosity (η*) of the ink is from 1,000 to 30,000 poise at the frequency of 10 rad/sec.

3. The ink as claimed in claim 1, wherein, at the temperature of printing, the complex viscosity (η*) of the ink at the frequency of 1 rad/sec is from 4 to 16 times the complex viscosity (η*) of the ink at the frequency of 10 rad/sec.

4. The ink as claimed in claim 1, wherein said resin component exhibits a heat curing reaction in a temperature range from 100 to 210° C.

5. The ink as claimed in claim 1, wherein said resin component exhibits heat curing by a reaction of an aromatic dicarboxylic acid anhydride group or an aromatic dicarboxylic acid mono ester group with an epoxy group or a blocked isocyanate group, a reaction of a blocked isocyanate group with a hydroxyl group or a carboxyl group, a reaction product of an epoxy group with a hydroxyl group, a carboxyl group or an amide group, or a combination of said reactions.

6. The ink as claimed in claim 1, which comprises from 30 to 300 parts by weight of the filler having an average particle size of less than 1.0 μm per 100 parts by weight of the resin component.

7. The ink as claimed in claim 1, wherein the resin component comprises (a) a polyimidosiloxane comprising a tetracarboxylic acid component and a diamine component containing a diaminopolysiloxane represented by formula (1), and (b) an epoxy compound and/or a blocked polyvalent isocyanate: 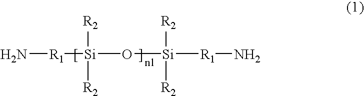
wherein R₁ represents a divalent hydrocarbon group or aromatic group, each R₂ independently represents a monovalent hydrocarbon group or aromatic group, and n1 represents an integer of 3 to 30.

8. The ink as claimed in claim 7, wherein the diamine component of the polyimidosiloxane is an aromatic diamine having a hydroxyl group and/or a carboxyl group on a side chain thereof.

9. A method for producing printed matter comprising a cured coating film, said method comprising printing the ink claimed in any one of claims 1 to 8 by screen printing and then heat-treating it at a temperature of 60 to 210° C.

10. The method according to claim 9, to produce printed matter having patterns defined by a line-and-space of 80 μm or less.

11. The method according to claim 9, to produce printed matter having patterns defined by a line-and-space of 50 μm or less.

12. The method according to claim 9, to produce printed matter having patterns defined by a line-and-space of 30 μm or less.

13. Printed matter comprising a cured coating film obtained by printing the ink claimed in any one of claims 1 to 8 by screen printing and then heat-treating it.

14. The printed matter according to claim 13, which has patterns defined by a line-and-space of 80 μm or less.

15. The printed matter according to claim 13, which has patterns defined by a line-and-space of 50 μm or less.

16. The printed matter according to claim 13, which has patterns defined by a line-and-space of 30 μm or less.
